(19) United States
(12) Patent Application Publication
(10) Pub. No.: US 2002/0144440 A1
(43) Pub. Date: Oct. 10, 2002

(54) Memorabilia collection method and means

(76) Inventor: Anna Maria Le Sueur, Auckland (NZ)

Correspondence Address: Jacobson Holman, Professional Limited Liability Company, 400 Seventh Street, N.W., Washington, DC, 20004-2218, US

(21) Appl. No.: 10/095,123

(22) Filed: Mar. 12, 2002

(30) Foreign Application Priority Data
Mar. 13, 2001 (NZ) 510540
Apr. 18, 2001 (NZ) 511186

(51) Int. Cl. G09F 19/00

(52) U.S. Cl. 40/530

(57) ABSTRACT

The present invention relates to a method of collecting memorabilia of a person and/or an event, the method or comprising or including the steps of:

a) providing a plurality of memorabilia receiving means,

b) allowing the memorabilia receiving means to be taken and subsequently used by any one or more persons,

c) allowing and/or facilitating at least some of the memorabilia receiving means to be delivered to at least one predetermined addressee

d) colating the at least some of the memorabilia receiving means that are delivered to the addressee into an album.

The invention also relates to a kit for collecting of memorabilia or a person and/or an event, a retailable item and a system for collecting memorabilia of a person and/or an event.

The present invention relates to a memorabilia collection method and collection means and in particular but not solely to the application of this method and the use of the means in association with an event of significance of a person, or group of persons.

### BACKGROUND

Events of significance to a person or to a group of people often occur. Such events may include a wedding, retirement, a birthday of significance, a wedding or other anniversary or the like.

For such events, it is common for wishes to the person or people concerned to be written down on cards such as greeting cards or the like. However it is sometimes also desirable for people to provide messages of memories that they have of a persons life or with a persons life. Indeed at 21st birthday celebrations, it is often common for photographs or other items of the person's history to be displayed, with a view to revealing what that person's history and memories of that history are like. Such aspects of memories are often collected in a relatively haphazard way. Photographs of different sizes and in different formats may be pasted to a large cardboard sheet for example. Such messages of well wishing and of memories are often ultimately provided in a random manner. They often provide, whilst with good intentions, a messy product in which an event of significance of a person or people is celebrated or recognised.

Another example of such an occasion may be a funeral service or memorial service. It is common to find a condolence or obituary book which allows a person attending the funeral to leave comments of condolence and of memories in the book to provide a permanent record of such messages and also to aid in the grieving process. The problem with providing a notebook is that it is often difficult for people to think of appropriate things to write in situations where their thoughts are perhaps not able to be expressed in the desired manner. Also at a funeral service, due to the number of people that may be attending, persons who wish to leave a note or comment may not have the opportunity to do so. It is therefore desirable to allow for a person who has attended a funeral or memorial service to be provided with the opportunity of noting comments and collecting articles of memory such as photographs, at a time that is more convenient and more conducive.

### OBJECT OF THE INVENTION

It is therefore an object of the present invention to provide a memorabilia collection method and means which provides the abovementioned desiderata, or avoids the abovementioned disadvantages, or which will at least provide the public with a useful choice.

### STATEMENTS OF THE INVENTION

Accordingly the present invention consists in a method of collecting memorabilia of a person and/or an event, the method comprising or including the steps of:

a) providing a plurality of memorabilia receiving means,

b) allowing the memorabilia receiving means to be taken and subsequently used by any one or more persons,

c) allowing and/or facilitating at least some of the memorabilia receiving means to be delivered to at least one predetermined addressee,

d) collating the at least some of the memorabilia receiving means that arc delivered to the addressee, into an album.

Preferably the allowing or facilitating the delivery of the memorabilia receiving means is via provision of one or more envelope(s) associated with each memorabilia receiving means and wherein at least one of the one or more envelopes is addressed to, or is to be addressed to, the at least one predetermined addressee.

Preferably the use by any one or more persons includes the one or more persons providing memorabilia on and/or in the memorabilia receiving means in the form of at least one or more of written comments, memories, well-wishing; photos or other memorabilia.

In a further aspect the present invention consists in a kit for collecting of memorabilia of a person and/or an event, the kit comprising or including,

a) a plurality of memorabilia receiving means, and

b) an album of a complementary nature to the memorabilia receiving means.

Preferably the kit includes such a box or stand or the like.

Preferably the kit further contains one of more list(s) of instructions.

Preferably at least one of the one or more list(s) of instructions includes instructions on providing a plurality of the memorabilia receiving means at a the location.

Preferably the instructions include recommending any one or more of the steps associated with a method as herein described.

Preferably the complementary nature between the album and memorabilia receiving means is of a graphic similarity nature.

Furthermore preferably the complementary nature between the memorabilia receiving means and the album is for the encouragement of the securing of memorabilia receiving means in a designated position within the album.

Preferably each of the plurality of memorabilia receiving means has a first envelope associated with it to facilitate delivery of the memorabilia receiving means to an address.

Preferably each of the plurality of the memorabilia receiving means has a second envelope associated with it to contain the memorabilia receiving means and associated first envelope when displayed in the box or stand or the like, thereby facilitating collection of the memorabilia receiving means and associated first envelope from the box or stand or the like by a person who will use the memorabilia receiving means.

In a further aspect the present invention consists in, as a retailable item, a means for collecting memorabilia of a person and/or event comprising or including,

a) a plurality of memorabilia receiving means, and

b) an album of a complementary nature to the memorabilia receiving means.

Preferably the retailable item includes such a box or stand or the like.

Preferably the retailable item further contains one of more list(s) of instructions.

Preferably the list of instructions include instructions on providing a plurality of the memorabilia receiving means at a location.

Preferably the instructions include recommending any one or more of the steps associated with a method as herein described.

Preferably the complementary nature between the album and memorabilia receiving means is of a graphic similarity nature.

Furthermore preferably the complementary nature between the memorabilia receiving means and the album is for the encouragement of the securing of memorabilia receiving means in a designated position within the album.

Preferably each of the plurality of memorabilia receiving means has a first envelope associated with it to facilitate delivery of the memorabilia receiving means to an address. Preferably each of the plurality of the memorabilia receiving means has a second envelope associated with it to contain the memorabilia receiving mean and associated first envelope when displayed in the box or stand or the like, thereby facilitating collection of the memorabilia receiving means and associated first envelope from the box or stand or the like by a person who will use the memorabilia receiving means.

In a further aspect the present invention consists in a system for collecting memorabilia of a person and/or an event the system comprising or including the steps of:

providing a plurality of memorabilia receiving means, and an album of a complementary nature to the memorabilia receiving means, and a list of instructions recommending making the memorabilia receiving means available so that at least one or more people can take at least one of the memorabilia receiving means for subsequent (and preferably in a different place) providing of memorabilia to the memorabilia receiving means,

that the at least one or more people deliver or have delivered the memorabilia receiving means, with the memorabilia provided, to a pre-determined addressee.

collating the at least some of the memorabilia receiving means that are delivered to the addressee into the album.

Preferably the memorabilia receiving means is selected from any one or more of a letter, card, envelope, and note.

Preferably the memorabilia receiving means is a letter or card (and before use, is preferably provided in or with one or more envelopes).

Preferably each of the plurality of memorabilia receiving means has a first envelope associated with it thereby facilitating delivery of the memorabilia receiving means to the pre-determined addressee. Preferably the first envelope is pre-addressed (or allows for the envelope to be pre-addressed by a person making the memorabilia receiving means available) to the pre-determined addressee.

Preferably each of the plurality of the memorabilia receiving means has a second envelope associated with it to contain the memorabilia receiving mean and associated first envelope, thereby facilitating collection or up-take of the memorabilia receiving means and associated first envelope by a person who will use the memorabilia receiving means.

Alternatively the memorabilia receiving means is merely an envelope into which an item of memory can be inserted.

Preferably in use, the memorabilia receiving means is used by a person by conducting any one or more of the following including writing on the memorabilia receiving means, applying to or securing to the memorabilia receiving means a photograph or other item of a kind relating to a memory of the person or event to be remembered.

Preferably the memorabilia receiving means are provided at a location or plurality of locations as a plurality in a containing means such as a box or stand or similar.

Alternatively the memorabilia receiving means are delivered to the at least one or more persons e.g. by mail or e-mail.

Preferably the delivery and the instructions for delivery of the memorabilia receiving means after use by the at least one or more persons is to an addressee who is a relation or acquaintance or a funeral director.

Alteratively, the addressee is a service provider providing the service of collating the at least some of the memorabilia receiving means into one or more of the albums. Preferably the instructions recommend the use of the memorabilia receiving means for providing memories and/or the provision of thoughts/messages of condolence/messages of well wishing.

Preferably the memorabilia receiving means and methods are used in relation to the situation where a person has deceased and where the location of availability of the memorabilia receiving means is at a funeral or memorial service.

Alternatively it is made available in situations where an event of significance or milestone in a persons life is reached such as for example a wedding, birthday, graduation, retirement, anniversary.

In a further aspect the present invention consists in a system for collecting memorabilia of a person and/or event substantially as herein described with reference to any one or more of the Figures and/or Examples.

In a further aspect the present invention consists in a method of collecting memorabilia of a person and/or event substantially as herein described with reference to any one or more of the Figures and/or Examples.

In a further aspect the present invention consists in a kit for collecting memorabilia of a person and/or event substantially as herein described with reference to any one or more of the Figures and/or Examples.

In a further aspect the present invention consists in a retailable item comprising a means for collecting memorabilia of a person and/or event substantially as herein described with reference to any one or more of the Figures and/or Examples.

This invention may also be the broadly to consist in the parts, elements and features referred to or indicated in the specification of the application, individually or collectively, and any or all combinations of any two or more of the parts, elements or features, and where specific integers are mentioned herein which have known equivalents in the art to which this invention relates, such known equivalents are deemed to be incorporated herein as if individually set forth.

### DESCRIPTION OF THE DRAWINGS

FIGS. 1a-1e illustrate a preferred sequence used in the methods of the present invention,

FIG. 2 illustrates a proposed set up to be provided for example at a church or memorial service and includes some of the means to allow the performing of the methods of the present invention.

### DETAILED DESCRIPTION OF THE INVENTION

The present invention has applications in diverse situations including use where an event of significance or milestone in a person's life is reached such as for example a birthday, wedding, retirement graduation, wedding anniversary or the like. Its application to such a diverse range events will be recognised and will now be described in detail with respect to the examples of the passing away of a person, and a wedding anniversary.

Death of a Person

At a funeral service, memorial service, tangi or any other gathering where people will be congregated because of the death of a person a kit as an embodiment of the present invention may be on offer to those people congregated. With reference to the physical items involved in such an embodiment of the present invention, what is on offer at such a service is a convenient means of allowing a person to note down memories, thoughts, and reflections, attach photographs and generally to collect any appropriate memorabilia in respect of the deceased person.

In the most preferred form, such a memorabilia collecting means is of a kind which allows for a person who has attended the service, to take an individual memorabilia receiving means to provide memories via the memorabilia collecting means, at their convenience and in their own time. In the most convenient form, such memorabilia receiving means as described may come in the form of a piece of paper or preferably a more rigid card substrate which provides room for a person who has taken the memorabilia receiving means to write comments such as memories or messages of condolence or any other appropriate text that he or she desires to note. The card may also provide for regions thereon not just for providing text but also for allowing any other things of significance and of memories in relation to the deceased to be attached. By way of example, the memorabilia receiving means may be provided with regions for allowing a photograph to be attached or engaged therewith. Certainly where reference herein is made to memorabilia, it may include the likes of written notes, photographs and any item or comment relating to the memories or thoughts that that person has of the deceased.

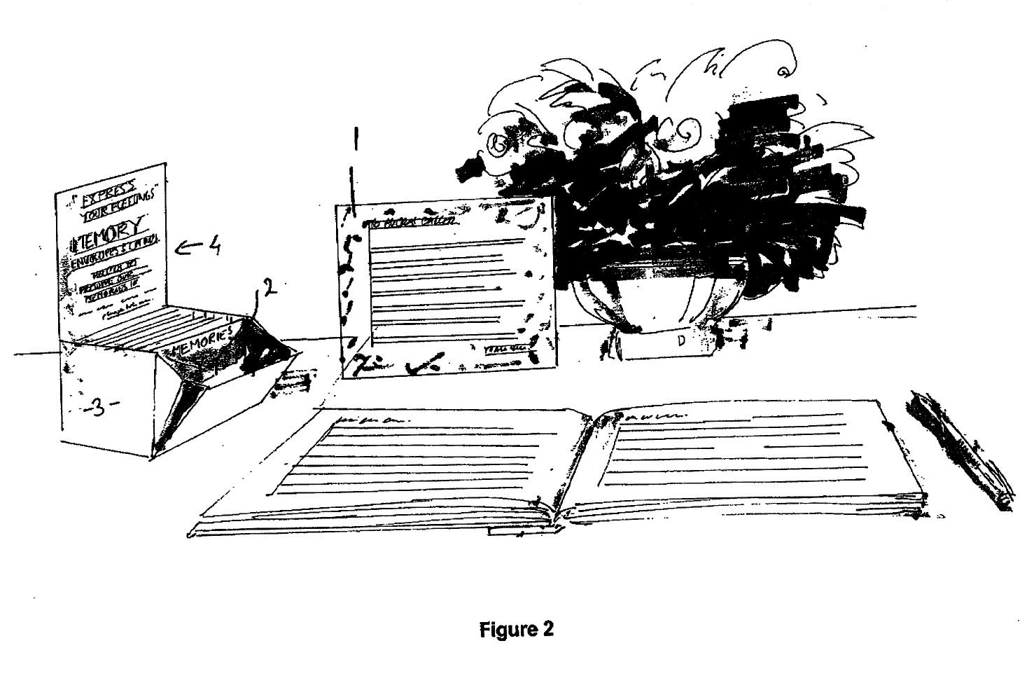

With reference to the figures, memorabilia receiving means may consist solely of a card 1 as for example shown in FIG. 2, or the card may form part of the memorabilia receiving means wherein another part thereof includes an envelope 2. With reference to FIG. 2, a plurality of memorabilia receiving means may be provided and may be provided in the form wherein the card 1 is located within the envelope and is presented at a reasonably prominent location within a church where the funeral is to take place. In the most preferred form, the plurality of memorabilia receiving means are provided in a location and in a form so that it is clear to attendees of the service that these arc for taking with them and for allowing their use at a later and more convenient time. With reference to FIG. 2, a plurality of such memorabilia receiving means are provided within a display box 3 and may include indicia 4, for highlighting the purpose of the memorabilia receiving means.

Since it may not be immediately apparent to people exactly the procedure that may be followed in terms of use of the present invention it is desirable for instructions to be included. Such instructions may be provided as a separate insert within the envelope, printed on the envelope or may be printed on the back of the card 1. Alternatively or additionally the instructions may also be provided on the box 3. Essentially, the memorabilia receiving means (1, 2) is intended to be taken away by people attending the service to allow for them to add their memories of the deceased at their own time and at a more suitable memory conducive environment such as at home and after the service has taken place. Whilst the memorabilia receiving means may be completed at the service, the environment of a funeral service is often not conducive to allow people to provide meaningful comments as they are in an unfamiliar environment.

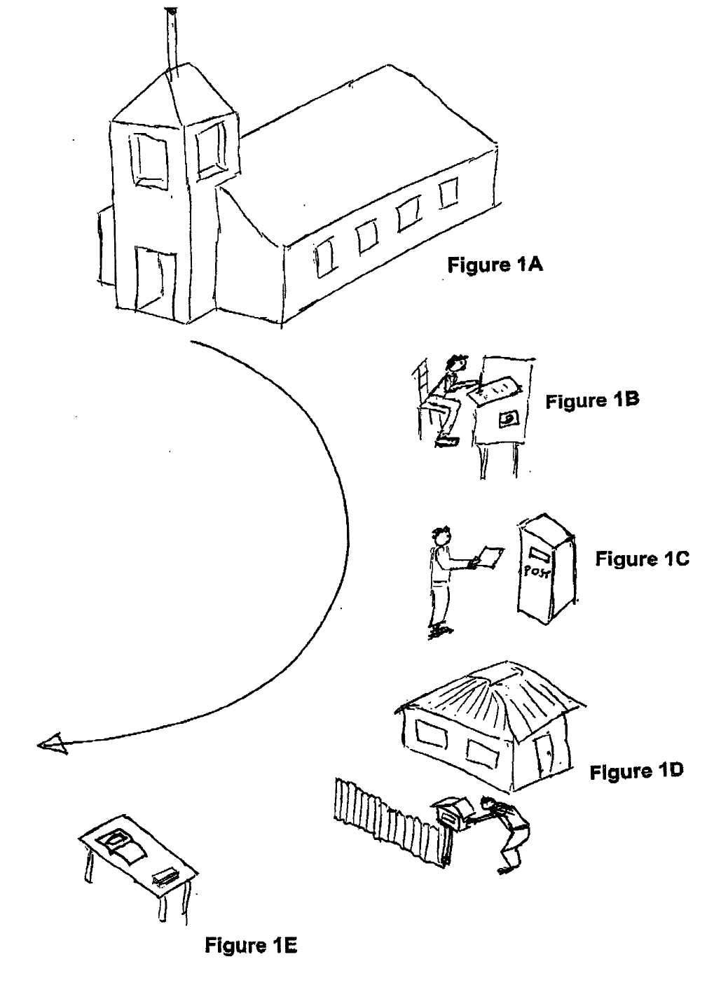

Once the person has added their memories to the memorabilia receiving means, with the convenience of the envelope 2 which is preferably provided, their memories (in a form of for example text/photos or the like) may be posted as in the example of FIG. 1c. The provision of the envelope as part of that which is on offer at the service, assists in the convenience of using the present invention. Indeed the envelopes which may be provided may be pre-addressed. As an alternative form the individual who has taken one of the memorabilia receiving means may both provide their own envelope and/or complete the address details so that their memories of the deceased are delivered to an addressee, such as for example shown in FIG. 1d. In the most preferred form, all of the plurality of items provided at the service are to be delivered to the same addressee however more than one addressee may in certain circumstances be appropriate, where for example a single funeral service is held for more than one deceased person.

A further embodiment of the invention may provide that the memorabilia receiving means and envelope (whether addressed or not) for delivery back to the pre-determined addressee, and/or with instructions may all together be provided in a second envelope to facilitate up-take of the memorabilia receiving means and associated envelope and/or instructions, from the display at the conclusion of a service.

The addressee will collect the memorabilia receiving means which are delivered for example by post to the addressee after which the memories are transferred to an album. Indeed where a card 1 is provided as part of the memorabilia receiving means, the card can be provided for example by adhering to, or by placing in pockets within the album. Photographs or other separate items which may be provided within the envelope that are delivered to the addressee may also have an appropriate place for being provided within the album.

In terms of presentation of the memories of the deceased that are sent by people and are delivered to the addressee for inclusion in the album, the album will have regions provided on at least some and preferably at least every second (and maybe every page) of the album which are specifically designated for receiving a card or letter. Such specific designation may for example be provided in the form of markings on the page such as lines or graphics and perhaps text, to indicate that a card is to be received at that region on a page. For example the card may be of a rectangular shape and a corresponding rectangular shaped box is drawn on a page where such a card is to be provided. Indeed each region of either the page and/or the back of the card may be provided with a pre-applied adhesive which may be exposed shortly before a card is provided to that region on the page of the album. An example would be the use of double sided tape for the purposes of such adhering. Alternatively the album may be provided with slots or folded portions or regions where allowing for a card to slot or engage with the page in the album. For example if a card is of a rectangular shape, diagonal slots may be provided on the page to allow each corner of the card to slot into such slots.

It is highly likely, that peoples's memories of the deceased will also include photographs, newspaper clippings or other items of memorabilia and it is for these items that the album will also have regions on pages for receiving such other memorabilias.

Graphics or designs on the card 1 and graphics provided on the album are preferably of a complementary kind so that there is a consistency in presentation of the album and the memories that have been sent to the addressee. The style of appropriate graphics provided on the card are preferably also repeated on the pages within the album.

Whilst reference is being made to the use of a card and preferably a card with an envelope as the form of the memorabilia receiving means of the present invention, it may be that the envelope is of a kind which incorporates a region for allowing memories to be written down. Envelopes of a foldout kind where once folded out, a region for writing on is provided for example can be used to this extent. Once the envelope has been written on it can be re-folded into the form of an envelope for mailing to the addressee.

The number of attendees at a service vary significantly. It is to this extent that the album is of a kind which allows for additional pages to be added as and when required to accommodate the received memorabilia. It is envisaged that for some people attending the service, it will not be appropriate or convenient to take a memorabilia receiving means for later completion and sending to the addressee, the album of the present invention may include pages of a kind providing regions to allow for attendees in such a category, to write comments in the album at the service.

In respect of collating the memorabilia providing means and any additional memories that are delivered to the addressee, some flexibility in the layout of the album may be provided. Certainly not everyone who has attended a funeral will have photos or additional memorabilias for inclusion in the album. It is to this extent that pages can be added or removed from the album to suit. For example a card which has written memories from a particular person may also include photographs. It will be desirable for the card and the photographs that have been sent to the addressee to be located proximate to each other in the album. Therefore a first page of the album may provide a region for receiving the card whereas the opposite page in the album may be provided for receiving the photos. Where a card is received without any photos, that opposite page may be removed or may not be present in the album and instead a page for receiving a card from another person may be located on an opposite page.

As another option, the card 1 may provide a region for adhering a photograph of a memory of the deceased thereto.

Wedding Anniversary

The memorabilia collection method and means of the invention are also equally applicable for celebration of a wedding anniversary. For example, whether before or at the actual celebration party of such an event, the memorabilia receiving means of the invention may be distributed to, or collected by, persons wishing to contribute memories, thoughts or other memorabilia. The album may then be assembled by the pre-determined addressee (for example) prior to a celebration party for presentation at that party. Alternatively the album may be assembled after the party has occurred (the display box being displayed at the party, and memorabilia receiving means being taken away from the party for later completion and posting back).

It is envisaged by the inventor tat the items of the present invention will be available for retail as a set. The set will include the album and the memorabilia receiving means and may also include the presentation stand 3. Such a unit is likely to be provided as an item of retail at for example book stores or may be offered by the funeral service business who are making the arrangements for the funeral of the deceased person.

From the example of the use of the present invention and methods of the present invention to a situation of the passing away of a person, or the celebration of an anniversary, it is easily recognised that the invention has application to other situations.

Indeed the making available of their memorabilia providing means may be such that it need not occur at a single location such as where people congregated e.g. at their funeral (as per the above examples). The distribution of the memorabilia providing means may be appropriate to the extent that such memorabilia providing means are mailed to people who are likely to be wishing to make contributions to the memory of a person and are likely to be attending an event to celebrate the event of significance of that person. Indeed the memorabilia providing means may be mailed to people who are likely to attend a wedding or birthday celebration where it is mailed accompanying an invite to the event.

The memorabilia providing means as an enclosure with the invite or forming part of the invite, will allow for such a person who wishes to make a contribution to the history or memory of a person to add aspects or details of memories that they have. The memorabilia providing means may then be returned to a single addressee or may be brought along to the event or celebration of the event of significance of that person for collection.

1. A method of collecting memorabilia of a person and/or an event, the method comprising or including the steps of:
a) providing a plurality of memorabilia receiving means,
b) allowing the memorabilia receiving means to be taken and subsequently used by any one or more persons,
c) allowing and/or facilitating at least some of the memorabilia receiving means to be delivered to at least one predetermined addressee,
d) collating the at least some of the memorabilia receiving means that are delivered to the addressee, into an album.

2. A method as claimed in claim 1 wherein the allowing or facilitating the delivery of the memorabilia receiving means is via provision of one or more envelope(s) associated with each memorabilia receiving means and wherein at least one of the one or more envelopes is addressed to, or is to be addressed to, the at least one predetermined addressee.

3. A method as claimed in claim 2 wherein the use by any one or more persons includes the one or more persons providing memorabilia on and/or in the memorabilia receiving means in the form of at least one or more of written comments, memories, well-wishing; photos or other memorabilia.

4. A kit for collecting of memorabilia of a person and/or an event, the kit comprising or including,
a) a plurality of memorabilia receiving means, and
b) an album of a complementary nature to the memorabilia receiving means.

5. A kit as claimed in claim 4 wherein the kit includes such a box or stand or the like.

6. A kit as claimed in claim 5 wherein the kit further contains one of more list(s) of instructions detailing the use of the kit.

7. A kit as claimed in claim 6 wherein the complementary nature between the album and memorabilia receiving means is of a graphic similarity nature.

8. A kit as claimed in claim 7 wherein the complementary nature between the memorabilia receiving means and the album is for the encouragement of the securing of memorabilia receiving means in a designated position within the album.

9. A kit as claimed in claim any one of claims 3 to 8 wherein each of the plurality of memorabilia receiving means has a first envelope associated with it to facilitate delivery of the memorabilia receiving means to an address.

10. A kit as claimed in claim 9 wherein each of the plurality of the memorabilia receiving means has a second envelope associated with it to contain the memorabilia receiving means and associated first envelope when displayed in the box or stand or the like, thereby facilitating collection of the memorabilia receiving means and associated first envelope from the box or stand or the like by a person who will use the memorabilia receiving means.

11. A retailable item, comprising a means for collecting memorabilia of a person and/or an event comprising or including:
a) a plurality of memorabilia receiving means, and
b) an album of a complementary nature to the memorabilia receiving means.

12. A retailable item as claimed in claim 11 wherein the retailable item includes a box or stand or the like.

13. A retailable item as claimed in claim 12 wherein the retailable item further contains one of more list(s) of instructions.

14. A retailable item as claimed in claim 13 wherein one of the one or more list(s) of instructions includes instructions on providing a plurality of the memorabilia receiving means at a location for up take of a memorabilia receiving means by a person to use the memorabilia receiving means.

15. A retailable item as claimed in claim 14 wherein the complementary nature between the album and memorabilia receiving means is of a graphic similarity nature.

16. A retailable item as claimed in claim 15 wherein the complementary nature between the memorabilia receiving means and the album is for the encouragement of the securing of memorabilia receiving means in a designated position within the album.

17. A retailable item as claimed in claim 16 wherein each of the plurality of memorabilia receiving means has a first envelope associated with it to facilitate delivery of the memorabilia receiving means to an address.

18. A retailable item as claimed in claim 17 wherein each of the plurality of the memorabilia receiving means has a second envelope associated with it to contain the memorabilia receiving mean and associated first envelope when displayed in the box or stand or the like, thereby facilitating collection of the memorabilia receiving means and associated first envelope from the box or stand or the like by a person who will use the memorabilia receiving means.

19. A system for collecting memorabilia of a person and/or an event the system comprising or including the steps of:
providing a plurality of memorabilia receiving means, and an album of a complementary nature to the memorabilia receiving means, and
a list of instructions recommending making the memorabilia receiving means available so that at least one or more people can take at least one of the memorabilia receiving means for subsequent (and preferably in a different place) providing of memorabilia to the memorabilia receiving means,
that the at least one or more people deliver or have delivered the memorabilia receiving means, with the memorabilia provided, to a predetermined addressee,
collating the at least some of the memorabilia receiving means that are delivered to the addressee into the album.

20. A system as claimed in claim 19 wherein the memorabilia receiving means is selected from any one or more of a letter, card, envelope, and note.

21. A system as claimed in claim 20 wherein the memorabilia receiving means is a letter or card, and before use, is preferably provided in or with one or more envelopes.

22. A system as claimed in claim 21 wherein each of the plurality of memorabilia receiving means has a first envelope associated with it thereby facilitating delivery of the memorabilia receiving means to the pre-determined addressee.

23. A system as claimed in claim 22 wherein the first envelope is pre-addressed (or allows for the envelope to be pre-addressed by a person making the memorabilia receiving means available) to the pre-determined addressee.

24. A system as claimed in claim 23 wherein each of the plurality of the memorabilia receiving means has a second envelope associated with it to contain the memorabilia receiving mean and associated first envelope, thereby facilitating collection or up-take of the memorabilia receiving means and associated first envelope by a person who will use the memorabilia receiving means.

25. A system as claimed in claim 20 wherein the memorabilia receiving means is merely an envelope into which an item of memory can be inserted.

26. A system as claimed in claim 24 or 25 wherein in use, the memorabilia receiving means is used by a person by conducting any one or more of the following including writing on the memorabilia receiving means, applying to or securing to the memorabilia receiving means a photograph or other item of a kind relating to a memory of the person or event to be remembered.

27. A system as claimed in claim 26 wherein the memorabilia receiving means are provided at a location or plurality of locations as a plurality in a containing means such as a box or stand or similar.

28. A system as claimed in claim 26 wherein the memorabilia receiving means are delivered to the at least one or more persons e.g. by mail or e-mail.

29. A system as claimed in claim 27 or 28 wherein the delivery and the instructions for delivery of the memorabilia receiving means after use by the at least one or more persons is to an addressee who is a relation or acquaintance or a funeral director.

30. A system as claimed in claim 28 wherein the addressee is a service provider providing the service of collating the at least some of the memorabilia receiving means into one or more of the albums.

31. A system as claimed in claim 29 or 30 wherein the instructions recommend the use of the memorabilia receiving means for providing memories and/or the provision of thoughts/messages of condolence/messages of well wishing.

32. A system as claimed in claim 31 wherein the memorabilia receiving means and methods are used in relation to the situation where a person has deceased and where the location of availability of the memorabilia receiving means is at a funeral or memorial service.

33. A system as claimed in claim 31 wherein the memorabilia receiving means are made available in situations where an event of significance or milestone in a persons life is reached such as for example a wedding, birthday, graduation, retirement, anniversary.
